(19) United States
(12) Patent Application Publication
(10) Pub. No.: US 2003/0111994 A1
(43) Pub. Date: Jun. 19, 2003

(54) Sensor arrangement

(76) Inventor: Erik Mannle, Oberkich (DE)

Correspondence Address: BOURQUE & ASSOCIATES, P.A., Suite 301, 835 Hanover Street, Manchester, NH, 03104, US

(21) Appl. No.: 10/289,202

(22) Filed: Nov. 6, 2002

(30) Foreign Application Priority Data
Nov. 6, 2001 (GB) 0126608.9

(51) Int. Cl. G01N 27/00

(52) U.S. Cl. 324/71.1

(57) ABSTRACT

A linear sensor in which a first slider is connected to a second slider by a shaft. The movement of the first slider causes the second slider to move in response. The second slider is connected to a track potentiometer such that the resistance of the potentiometer varies with the movement of the first slider.

This invention relates to the field of linear sensors, and in particular, although not being limited to, the field of linear sensors for use in automotive applications.

Linear contact sensors can translate linear motion into a signal of a different form, for example an electrical voltage, the magnitude of which varies with the linear motion. A known problem with linear sensors is that it is very difficult to provide a sensor that has a cost-effective and functional seal for the moveable part of the sensor. It is an object of the present invention to provide a linear sensor that overcomes this problem.

According to a first aspect of the invention there is provided a sensor arrangement comprising a first slideable member and a second slideable member, the first slideable member being mechanically coupled to the second slideable member such that the motion of the first slideable member determines the motion of the second slideable member, the position of the second slideable member determining the output of the sensor arrangement.

Preferably, the second slideable member is substantially sealed from the first slideable member. This allows the sensor arrangement to be used in non-benign environments, for example in environments having high levels of humidity or where the sensor arrangement might become contaminated by dirt and/or other pollutants.

The sensor arrangement may further comprise a variable electrical resistor and the second slideable member comprises an electrical contact, the position of the electrical contact relative to the variable electrical resistor determining the output of the sensor arrangement. The sensor arrangement may also comprise a mechanical resistive element which, in use, urges the second slideable member towards a null position. This supplies the advantage that the tendency for a hysteresis effect to occur within the sensor arrangement is reduced.

It is preferred that the first slideable member is mechanically coupled to the second slideable member by a drive member. The first slideable member may comprise a rack and the drive member may comprise a first pinion, whilst the second slideable member may comprise a rack and the drive member may comprise a second pinion. An advantage of this is that the first slideable member may be driven by a moving object in a non-benign environment with the second slideable member being located in a more benign environment, providing increased protection for the more sensitive sensor elements from being damaged or being exposed to pollutants.

While the sensor that is the subject of the present invention is suitable for use in any application in which a linear sensor is called for, it has particular application in the automotive industry. A significant development area is ‘drive by wire’, in which pedal inputs, for example the amount of throttle or brake to be applied, are electrical signals that are transmitted to an electronic control unit that controls the response of the other vehicular systems. In such ‘drive by wire’ systems it is essential to know the position of each pedal relative to the pedal box to which the pedals are attached. Furthermore, it is essential to know if the driver has changed the position of the pedal box to effect a more comfortable driving position. The sensor of the present application has particular application in measuring the movement of such pedal boxes.

The invention will now be described, by way of example only, with reference to the following Figures in which:

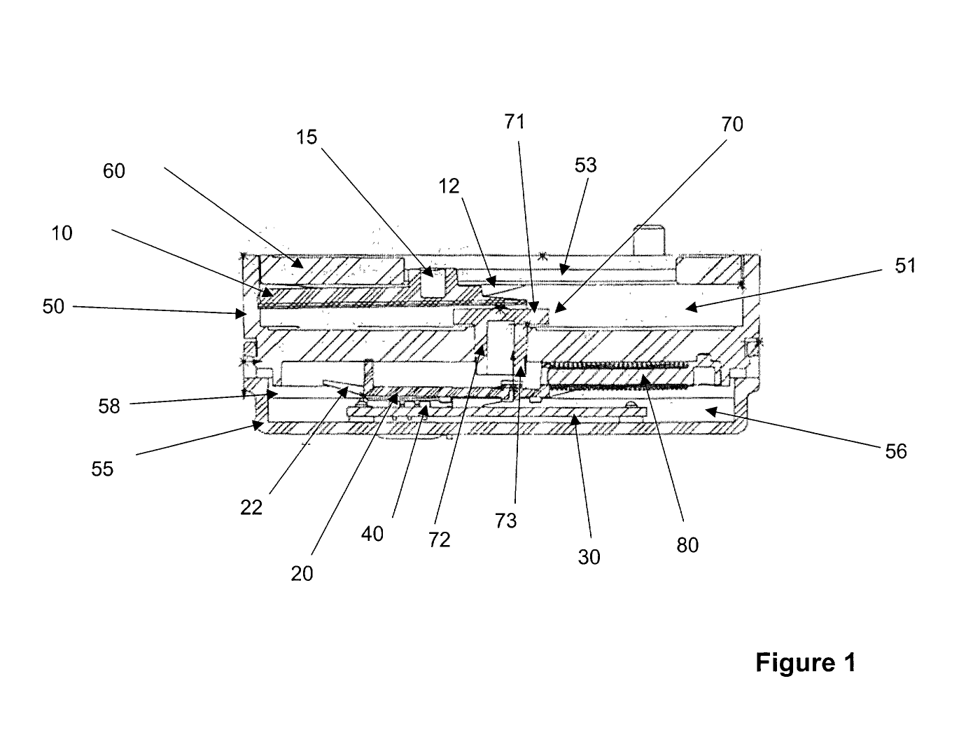

FIG. 1 shows a schematic depiction of a cross-section of a linear sensor according to the present invention;

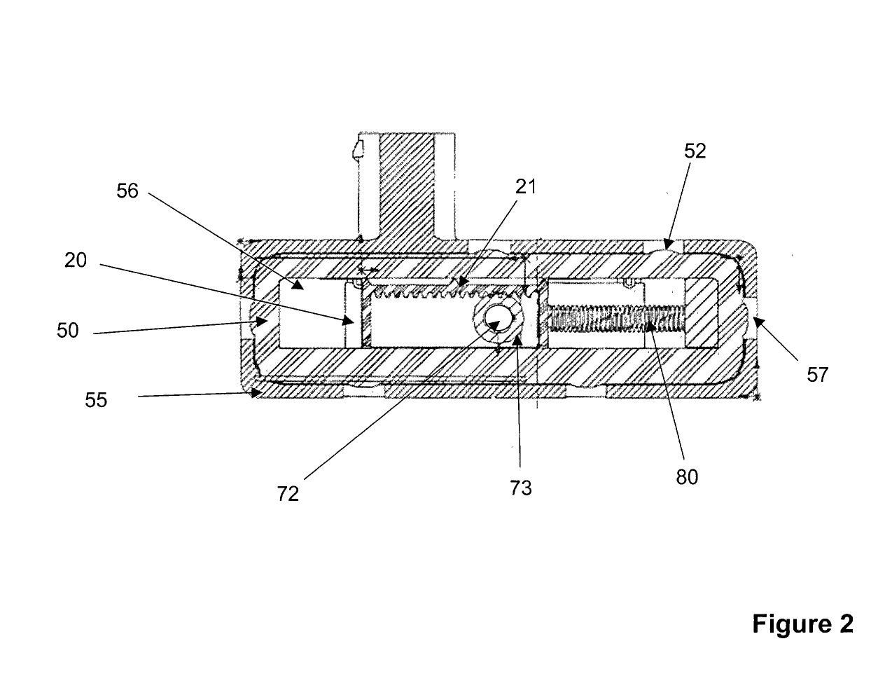

FIG. 2 shows a schematic depiction of a first section of a linear sensor according to the present invention; and

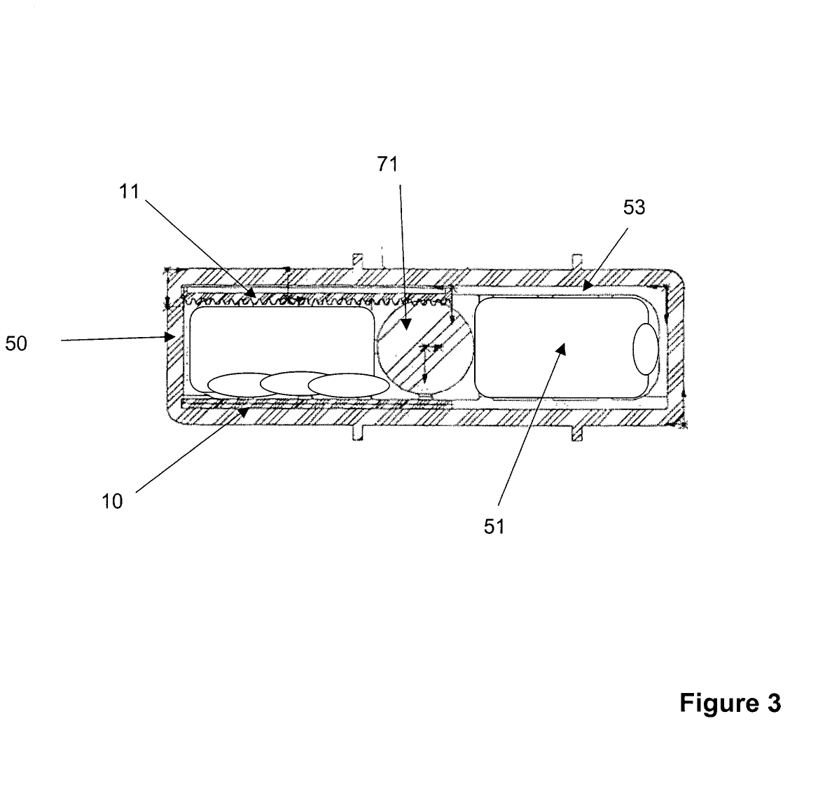

FIG. 3 shows a schematic depiction of a second section of a linear sensor according to the present invention.

FIG. 1 shows a cross-section of a linear sensor according to the present invention in which linear sensor 100 comprises first slideable element 10, second slideable element 20, track potentiometer 30, electrical contacts 40, first housing member 50, second housing member 55, restraining member 60 and mechanical coupling element 70.

First housing member 50 and second housing member 55 are mutually engageable and when engaged together define first cavity 51 and second cavity 56. The first slideable element 10 is located in the first cavity 51 and is restrained therein by restraining member 60 and the second slideable element 20 is located in the second cavity 56. First and second slideable elements are thus constrained respectively within first cavity 51 and second cavity 56 such that the slideable elements have only a single degree of freedom in which to move, that is the slideable elements can only move along a single, linear axis. First and second slideable elements are coupled together by mechanical coupling element 70, which comprises first pinion 71, spindle 72 and second pinion 73. Both the first and the second slideable elements comprise respective rack gears that mesh with the first pinion 71 and the second pinion 73 respectively. The spindle 72 is received within a circular hole formed within first housing member 50, with the diameter of the spindle being just less than the diameter of the hole.

First slideable element 10 comprises an engagement means 15 into which a rod or similar mechanism can be inserted, allowing the first slideable element to be connected to a moveable component. Electrical contacts 40 are connected to second slideable element 20 such that the electrical contacts are in connection with the tracks of track potentiometer 30. The mutual engagement of the first housing member and the second housing member partially seals the cavity containing the second slideable element, the electrical contacts and the track potentiometer. The spindle 72 provides at least a partial seal to the circular hole formed within the first housing member.

When the first slideable element 10 is moved along its axis of freedom the first rack gear meshes with the first pinion 71 such that the mechanical coupling element 70 is rotated. Second pinion 73 is engaged with the second rack gear and thus the rotation of the second pinion moves the second slideable element 20 along its axis of freedom.

The position of the electrical contacts along the length of the track potentiometer determines the resistance of the track potentiometer and thus as the electrical contacts move with the second slideable element, in response to the movement of the first slideable element, the resistance of the track potentiometer will vary in accordance with the movement of the second slideable element. The track potentiometer 30 has electrical outputs (not shown) to which electrical connections can be made, through which the resistance of the track potentiometer can be sensed through a number of known techniques.

Thus, as the first slideable element is moved along its axis the second slideable axis is moved along its axis, in response to the movement of the first slideable element, such that as the position of the first slideable element is varied the resistance of the track potentiometer varies accordingly. Measurement of the resistance allows the position of the first slideable element, and a moving component to which it is connected, to be sensed.

In a preferred embodiment of the sensor arrangement shown in FIG. 1, the sensor arrangement further comprises mechanical resistive element 80. This is connected in between the second slideable element and the first housing member and is biased to urge the second slideable element towards a null position. This null position corresponds to the position of the first slideable element at one of the limits of its movement within the first cavity, that is, also corresponding to one of the limits of a moveable component connected to the first slideable element. Te function of the mechanical resistive element is to ensure that when the first slideable element, and hence a connected moveable component, is in the position corresponding to the null position of the second slideable element the second slideable element is urged into the null position.

This arrangement provides that the hysteresis in the sensor is minimised as the second slideable element is always returned to its null position. Without the mechanical resistive element there is a possibility that the second slideable element is not always returned to its null position, due to play between the pinions and their respective rack gears, leading to inaccurate sensing of the position of the first slideable element (and any attached moveable component). The mechanical force exerted on the second slideable element must be sufficient to overcome the frictional forces present in the sensor arrangement but must not be of such a magnitude so as to significantly oppose the mechanical forces applied to the sensor arrangement by the moveable component, and thus interfere with the movement that the sensor is measuring.

FIG. 2 shows a schematic depiction of a first sectional view of the sensor arrangement depicted in FIG. 1 and described above. Second slideable element 20 comprises second rack gear 21 which engages with second pinion 73. The second slideable element 20 is connected to mechanical resistive element 80, which in a preferred embodiment comprises a rigid rod coupled to both the second slideable element and the first housing member with a spring mounted around the rod. The first and second housing members are mutually engaged using a resistance fit which is enabled by a plurality of protrusions 52 formed in the first housing member 50, which are received in a respective plurality of apertures 57 formed in the second housing member 55.

FIG. 3 shows a schematic depiction of a second sectional view of the sensor arrangement depicted in FIG. 1 and described above. The first slideable element 10 comprises first rack gear 11 which engages with first pinion 71. In order that the slideable elements are well seated within their respective cavities first housing member comprises a ledge 53 that extends around the perimeter of cavity 51, the ledge receiving the first slideable element 10. Furthermore, slideable element 10 may comprise leaf springs 12 (see FIG. 1) which are compressed when the first slideable element is restrained by the restraining member 60. In a similar manner, second housing member comprises a ledge 58 to receive second sliding element 20, which may comprise one or more leaf springs 22 (see FIG. 1).

Whilst the mutual engagement of the first and second housing members provides a partial seal for the components enclosed therebetween, there may be some applications for which further sealant means are required. This may be achieved, for example, by adding a gasket seal to the join between the first housing member and the second housing member. Furthermore, the interface between the spindle and the housing member that it passes through can be sealed through the application of a grease or alternatively a gasket seal. The electrical connectors through which the resistance of the potentiometer can be sensed can be connected to wires that can exit the sensor arrangement through a sealed aperture.

The use of the double rack and pinion system gives great flexibility in the design of a linear sensor arrangement. By careful selection of the number of gear teeth in the various gears, it is possible to design a sensor that can measure with increased precision or alternatively can measure over a greater range of movement. Additionally, the first slideable element may be made to move in the opposite direction to the second slideable element.

What is claimed is:

1. A sensor arrangement comprising a first slideable member and a second slideable member, the first slideable member being mechanically coupled to the second slideable member such that the motion of the first slideable member determines the motion of the second slideable member, the position of the second slideable member determining the output of the sensor arrangement.

2. A sensor arrangement according to claim 1, in which the second slideable member is substantially sealed from the first slideable member.

3. A sensor arrangement according to claim 1, in which the sensor arrangement further comprises a variable electrical resistor and the second slideable member comprises an electrical contact, the position of the electrical contact relative to the variable electrical resistor determining the output of the sensor arrangement.

4. A sensor arrangement according to claim 1, further comprising a mechanical resistive element which, in use, acts to urge the second slideable member towards a null position.

5. A sensor arrangement according to any of claim 1, in which the first slideable member is mechanically coupled to the second slideable member by a drive member.

6. A sensor arrangement according to claim 5, in which the first slideable member comprises a rack and the drive member comprises a first pinion.

7. A sensor arrangement according to claim 5, in which the second slideable member comprises a rack and the drive member comprises a second pinion.
